(19) United States
(12) Patent Application Publication
(10) Pub. No.: US 2008/0170862 A1
(43) Pub. Date: Jul. 17, 2008

(54) Monitoring Polarization Of A Signal Communicated According To Polarization Multiplexing

(76) Inventors: Olga I. Vassilieva, Plano, TX (US); Takao Naito, Plano, TX (US)

Correspondence Address: BAKER BOTTS L.L.P., 2001 ROSS AVENUE, SUITE 600, DALLAS, TX, 75201-2980, US

(21) Appl. No.: 11/622,520

(22) Filed: Jan. 12, 2007

(51) Int. Cl. H04B 10/00

(52) U.S. Cl. 398/152

(57) ABSTRACT

A system operable to monitor a polarization controller includes the polarization controller and a polarization controller monitor. The polarization controller polarizes the signal to yield a polarized signal comprising a first signal component and a second signal component, where the first signal component is orthogonally polarized with respect to the second signal component. The polarization controller monitor monitors a first polarization indicating waveform of the first signal component and a second polarization indicating waveform of the second signal component. The polarization controller monitor determines whether to adjust polarization of the received signal by polarization controller in accordance with the first polarization indicating waveform and the second polarization indicating waveform.

### TECHNICAL FIELD

This invention relates generally to the field of signal communication and more specifically to monitoring polarization of a signal communicated according to polarization multiplexing.

### BACKGROUND

Communication systems may communicate signals using polarization multiplexing. In polarization multiplexing, a signal is polarized and split into orthogonal signal components. Each signal component is encoded with data according to a modulation formation, for example, phase-shift keying (PSK) modulation. The signal components are then combined for transmission. A receiver polarizes the signal and splits the signal into two orthogonal signal components. Each signal component is then demodulated to retrieve the transmitted data. Polarization multiplexing may double the transmission capacity of a channel.

Polarization multiplexing, however, may experience difficulties. As an example, the state of polarization (SOP) of the signal may change during transmission from the transmitter to the receiver. Accordingly, the receiver may need to compensate for this change. Compensating for the change, however, may be difficult in certain situations.

### SUMMARY OF THE DISCLOSURE

In accordance with the present invention, disadvantages and problems associated with previous techniques for monitoring polarization may be reduced or eliminated.

According to one embodiment of the present invention, a transmitter modulator includes a polarization controller, a polarization beam splitter, a first modulator, a second modulator, a polarization indicating modulator, and a polarization beam combiner. The first modulator encodes a first signal component according to a first modulation format, and the second modulator encodes a second signal component according to a second modulation format, where the first signal component is orthogonally polarized with respect to the second signal component. The polarization indicating modulator modulates the first signal component to introduce a first polarization indicating waveform into the first signal component, and modulates the second signal component to introduce a second polarization indicating waveform into the second signal component. The polarization beam combiner combines the first signal component and the second signal component for transmission.

According to one embodiment of the present invention, a system operable to monitor polarization of a received signal includes a polarization controller and a polarization controller monitor. The polarization controller polarizes the signal to yield a polarized signal comprising a first signal component and a second signal component, where the first signal component is orthogonally polarized with respect to the second signal component. The polarization controller monitor monitors a first polarization indicating waveform of the first signal component and a second polarization indicating waveform of the second signal component. The polarization controller monitor determines whether to adjust polarization of the signal in accordance with the first polarization indicating waveform and the second polarization indicating waveform.

Certain embodiments of the invention may provide one or more technical advantages. A technical advantage of one embodiment may be that signal components communicated using polarization multiplexing may have polarization indicating waveforms that a receiver may use to adjust the polarization settings of the polarization controller. In the embodiment, a transmitter may modulate signal components to introduce polarization indicating waveforms into the signal components. A receiver may use the polarization indicating waveforms to determine whether the signal components are being properly polarized.

A technical advantage of one embodiment may be that the receiver may measure a polarization indicating value representing the polarization indicating waveforms. In the embodiment, if the measured polarization indicator value does not match an expected polarization indicator value, the receiver may initiate polarization adjustment.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates one embodiment of a system for communicating a signal using polarization multiplexing;

FIG. 2 illustrates an example of polarization multiplexing of a signal that may be performed by the system of FIG. 1;

FIG. 3 illustrates one embodiment of a transmitter that may be used with the system of FIG. 1;

FIGS. 4A and 4B illustrate examples of polarization indicator waveforms that may be used by the system of FIG. 1;

FIG. 5 illustrates one embodiment of a receiver that may be used with the system of FIG. 1;

FIGS. 6A through 6C illustrate examples of power levels of signal components of a signal experiencing a change in polarization; and

FIG. 7 illustrates one embodiment of a method for communicating a signal using polarization multiplexing.

### DETAILED DESCRIPTION OF THE DRAWINGS

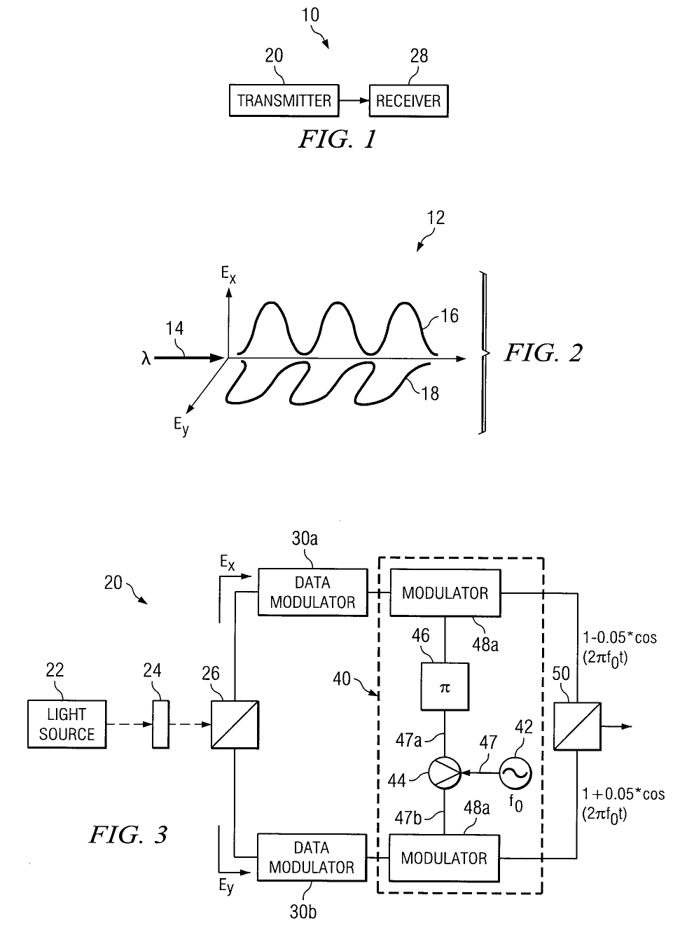

Embodiments of the present invention and its advantages are best understood by referring to FIGS. 1 through 7 of the drawings, like numerals being used for like and corresponding parts of the various drawings.

FIG. 1 illustrates one embodiment of a system 10 for communicating a signal using polarization multiplexing. According to the embodiment, signal components communicated using polarization multiplexing may have polarization indicating waveforms that a receiver may use to monitor polarization. In the embodiment, a transmitter may modulate signal components to introduce polarization indicating waveforms into the signal components. A receiver may use the polarization indicating waveforms to determine whether the signal components at the output of polarization controller are being properly polarized. In one embodiment, the receiver may measure a polarization indicating value representing the polarization indicating waveforms. In the embodiment, if the measured polarization indicator value does not match an expected polarization indicator value, the receiver may initiate polarization adjustment.

According to one embodiment, system 10 communicates signals. A signal may refer to an optical signal transmitted as light pulses. An optical signal may have a frequency of approximately 1550 nanometers, and a data rate of, for example, 10, 20, 40, or over 40 gigabits per second. A signal may communicate any suitable information such as voice, data, audio, video, multimedia, other information, or any combination of the preceding.

System 10 includes devices that may have components operable to perform the operations of the device. For example, a device may comprise logic, an interface, a memory, or any suitable combination of the preceding. “Logic” may refer to hardware, software, other logic, or any suitable combination of the preceding. Certain logic may manage the operation of a device, and may comprise, for example, a processor. “Processor” may refer to any suitable device operable to execute instructions and manipulate data to perform operations.

“Interface” may receive input, send output, perform suitable processing of the input and/or output, or any combination of the preceding, and may comprise one or more ports and/or conversion software. “Memory” may store and facilitate retrieval of information, and may comprise a Random Access Memory (RAM), a Read Only Memory (ROM), a magnetic drive, a disk drive, a Compact Disk (CD) drive, a Digital Video Disk (DVD) drive, a removable media storage, any other suitable data storage medium, or a combination of any of the preceding.

According to the illustrated embodiment, system 10 includes a transmitter 20 operable to communicate a signal to a receiver 28. Transmitter 20 and receiver 28 may communicate according to one or more modulation formats. A modulation format may refer to technique for modulating a signal in a particular manner to encode data into the signal. Examples of modulation formats include phase-shift keying (PSK) modulation.

According to one embodiment, PSK modulation may refer to differential PSK (DPSK) modulation. In DPSK modulation, phase shifts between successive bits represent bits. According to n-phase-shift keying (n-PSK) modulation, n different phase shifts may be used to encode p bits per symbol, where n=2^{p}. For example, differential binary PSK (DBPSK) uses two phase shifts to encode one bit per symbol, and differential quadrature PSK (DQPSK) uses four phase shifts to encode two bits per symbol.

According to one embodiment, transmitter 20 modulates a signal using polarization multiplexing to encode data in a signal. Receiver 28 demodulates the signal using polarization demultiplexing to decode the data encoded in the signal. Transmitter 20 and receiver 28 may perform modulation and demodulation as described with reference to FIG. 2.

FIG. 2 illustrates an example of polarization multiplexing of a signal that may be performed by the system of FIG. 1. Diagram 12 illustrates a signal encoded according to PSK modulation. In the example, a signal 14 with a wavelength λ is split into orthogonally polarized signal components 16 and 18. Signal component 16 is encoded according to one or more modulation formats, and signal component 18 is encoded according to one or more modulation formats. In the example, signal components 16 and 18 may be encoded according to the same modulation format, for example, PSK modulation format.

FIG. 3 illustrates one embodiment of transmitter 20 that may be used with system 10 of FIG. 1. Transmitter 20 may include one or more suitable components operable to encode data into a signal using polarization multiplexing. According to the illustrated embodiment, transmitter 20 includes a light source 22, a polarization controller 24, a polarization beam splitter (PBS) 26, data modulators 30, a polarization indicator modulator 40, and a polarization beam combiner (PBC) 50 coupled as shown.

According to the embodiment, light source 22 emits a light beam that may be encoded with bits to yield a signal that communicates information. Light source 22 may emit a continuous wave light beam that may be split into one or more signal components for encoding.

Polarization controller 24 polarizes the signal from light source 22 to yield orthogonal signal components. Polarization controller 24 may have any suitable setting to yield orthogonal signal components. For example, the polarization controller may be set to approximately 45 degrees.

Polarization beam splitter (PBS) 26 splits the signal to yield orthogonal signal components, where each signal component is to be modulated by a particular data modulator 30. In the illustrated embodiment, a first signal component is to be modulated by data modulator 30a, and a second signal component is to be modulated by data modulator 30b. The signal may be split in any suitable manner. According to one embodiment, the signal is split into orthogonal signal components Eₓ and E_{y}, where component Eₓ is for data modulator 30a, and component E_{y} is for data modulator 30b.

Data modulators 30 modulate a signal according to any suitable modulation format to encode data to yield an encoded signal. Data modulators 30a-b may use any suitable modulation format, and may use the same or different modulation formats.

According to one embodiment, data modulators 30a-b may modulate signals according to PSK modulation to yield PSK encoded signals. According to the embodiment, data modulator 30 may include one or more PSK data encoders. Each PSK data encoder encodes particular data into a signal component of a signal received by data modulator 30. A PSK data encoder may include a phase modulator that modulates the phase of a signal to encode the data into the signal.

According to another embodiment, data modulator 30 may also include a return-to-zero (RZ) module. The RZ module modulates the PSK signal according to RZ modulation to return the amplitude of the signal to zero between each pulse. RZ module may include a clock and an amplitude modulator. The amplitude modulator modulates the PSK signal according to the clock signal received from the clock. The amplitude modulator may represent any suitable amplitude modulator. In general, an example of an amplitude modulator is an intensity modulator such as a Mach-Zehnder modulator.

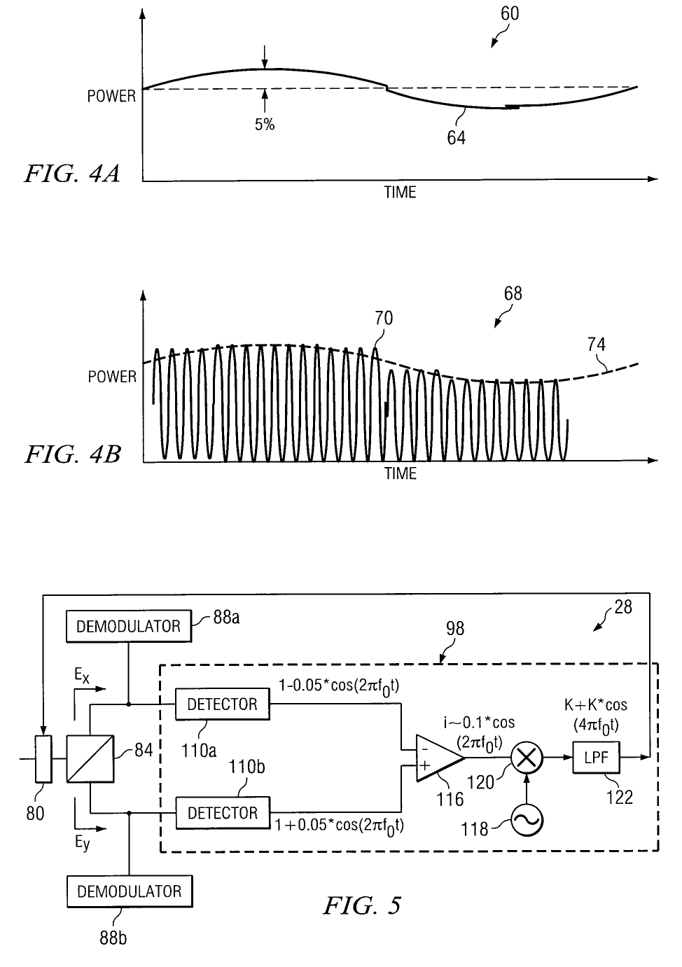

Polarization indicator modulator 40 modulates signal components to introduce polarization indicators into the signal components. The polarization indicators may be used to indicate whether there is a misalignment between the state of polarization (SOP) of the received signal components and the axes of a polarization beam splitter (PBS) at receiver 28. According to one embodiment, polarization indicator modulator 40 may introduce polarization indicating waveforms into the signal components. Examples of polarization indicating waveforms are described in more detail with reference to FIGS. 4A and 4B.

FIGS. 4A and 4B illustrate examples of polarization indicator waveforms that may be used by the system of FIG. 1. A polarization indicator waveform may be introduced into a particular signal component modulated by a particular data modulator 30. A polarization indicator waveform may have any suitable amplitude and frequency. The frequency may be very low relative to the bit rate of transmitter 20. Examples of frequency may include a frequency of less than one ten-thousandth of the bit rate of the RZ DPSK signal. For example, if the bit rate is 40×10⁹ bits per second (b/s), the frequency may be approximately between 1 kilohertz (kHz) and 20 kHz, such as 10 kHz.

The peak amplitude may be very small relative to the peak amplitude of a modulated PSK signal. Examples of peak amplitudes may include less than one-fourth, one-fifth, one-tenth, one-tenth, one-twentieth, or one-twenty-fifth of the total signal power, such as 5% of the total signal power.

FIG. 4A includes a diagram 60 illustrating a polarization indicator waveform 64 superimposed on PSK signal. In the illustrated example, polarization indicator waveform 64 has a relatively low frequency of approximately 10 kHz and low peak amplitude of approximately five percent of the total power.

FIG. 4B includes a diagram 68 illustrating a polarization indicator waveform 74 superimposed on RZ-DPSK signal 70. In the illustrated example, polarization indicator waveform 74 has a relatively low frequency of approximately 10 kHz and low peak amplitude of approximately five percent of the total power.

Referring back to FIG. 3, polarization indicator modulator 40 may include any suitable components for modulating the signal component to introduce a polarization indicating waveform. According to the illustrated embodiment, polarization indicator modulator 40 includes a low frequency oscillator (LO) 42, a splitter 44, a phase shifter 46, and modulators 48.

Low frequency oscillator (LO) 42 may provide a low frequency signal at a frequency of f₀ to splitter 44. Examples of frequency f₀ may include approximately 10 kHz. Splitter 44 may split the low frequency signal to yield polarization indicator signals 47a-b, which may be sent to modulators 48a-b, respectively. Phase shifter 46 may shift a signal of signals 47a-b to create a phase difference between signals 47a-b. The phase difference may be selected to allow receiver 28 to determine whether polarization at receiver 28 should be adjusted. For example, a phase shift of n may be selected.

Modulators 48 modulate the signal components according to polarization indicator signals 47a-b to introduce polarization indicating waveforms into the signal components. In the illustrated embodiment, the polarization indicator waveform resulting from polarization indicator signal 47a may be expressed as 1−0.05*cos (2nf₀t), and the polarization indicator waveform resulting from polarization indicator signal 47b may be expressed as 1+0.05*cos (2nf₀t).

Modulators 48 may modulate the signal components at any suitable point. According to the illustrated embodiment, modulators 48 modulate the signal components after they have been encoded with data. According to another embodiment, modulators 48 may modulate the signal components before they have been encoded with data.

Polarization beam combiner (PBC) 50 combines the encoded signal components to yield a signal for transmission to receiver 28.

Modifications, additions, or omissions may be made to transmitter 20 without departing from the scope of the invention. The components transmitter 20 may be integrated or separated according to particular needs. Moreover, the operations of transmitter 20 may be performed by more, fewer, or other components. Additionally, operations of transmitter 20 may be performed using any suitable logic. As used in this document, “each” refers to each member of a set or each member of a subset of a set.

FIG. 5 illustrates one embodiment of receiver 28 that may be used with system 10 of FIG. 1. Receiver 28 may include one or more suitable components operable to demodulate a signal using polarization demultiplexing. According to the illustrated embodiment, receiver 28 includes a polarization controller 80, a polarization beam splitter (PBS) 84, data demodulators 88, and a polarization controller monitor 98 coupled as shown.

Polarization controller 80 realigns the polarization state of the two orthogonally polarized incoming signals from transmitter 20 with the axes of a polarization beam splitter (PBS) 84 to avoid crosstalk between signals. Polarization controller 80 may have any suitable setting to align the polarization of the output orthogonally polarized signals to the input of the PBS. For example, polarization controller 80 may be set to approximately 45 degrees. According to one embodiment, polarization controller 80 may receive instructions from polarization controller monitor 98, as described in more detail below.

Polarization beam splitter (PBS) 84 splits the signal to yield orthogonal signal components, where each signal component to be demodulated by a particular data demodulator 88. In the illustrated embodiment, a first signal component is to be demodulated by data demodulator 88a, and a second signal component is to be demodulated by data demodulator 88b. The signal may split in any suitable manner. According to one embodiment, the signal is split into orthogonal signal components such that one signal component is aligned at or near 100% transmission along Eₓ and the other at or near 100% transmission along E_{y}, where component Eₓ is for data demodulator 88a, and component E_{y} is for demodulator 88b.

Data demodulators 88 demodulate the signal components to obtain the transmitted data. Data demodulators 88 may demodulate according to any suitable format, for example, PSK modulation. According to one embodiment, data demodulators 88 may include one or more PSK data decoders that demodulate the signal components according to PSK modulation. A PSK data decoder may demodulate a signal by comparing the phase shifts between successive bits. The PSK data decoder may split a signal to yield multiple signals and delay a signal to yield a delayed signal and a non-delayed signal. The PSK data decoder may then constructively and destructively interfere the delayed and non-delayed signals to compare the phases of successive bits to yield a PSK decoded signal corresponding to the data.

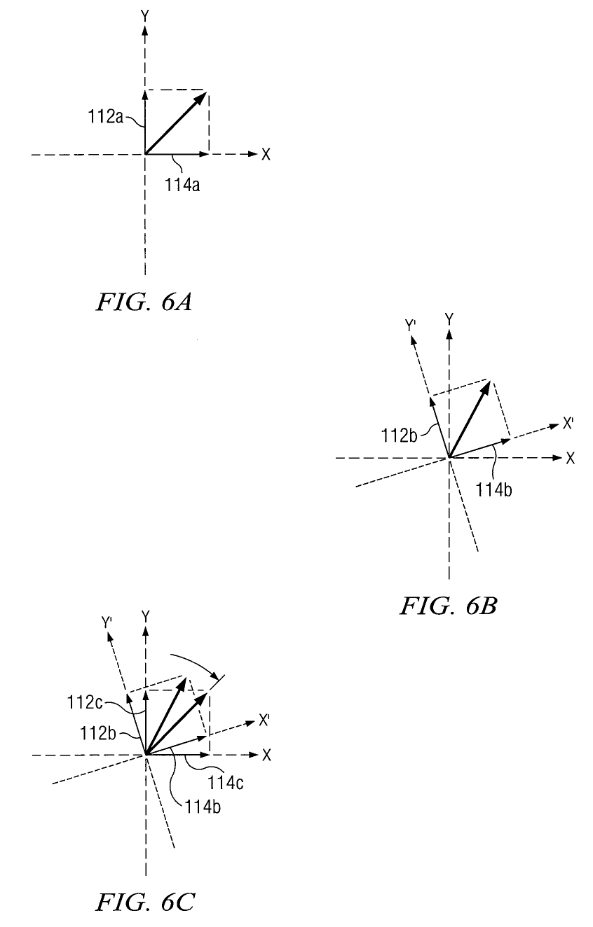

Polarization controller monitor 98 may monitor the polarization of the received signal for changes that may have occurred during transmission. Polarization controller monitor 98 may send instructions to polarization controller 80 to adjust the state of polarization of the received signal to compensate for changes. An example of a polarization adjustment is described in more detail with reference to FIGS. 6A through 6C.

FIGS. 6A through 6C illustrate examples of power levels of signal components of a signal experiencing a change in polarization. FIG. 6A illustrates power level 112a of a first signal component and power level 114a of a second signal component at transmitter 20. Power level 112a may be substantially similar to power level 114a.

FIG. 6B illustrates the power levels of the signal components as received at receiver 28. The polarization of the signal may rotate during transmission, which may result in crosstalk between signal components. In the example, a fraction of the power of the second signal component leaks into the power of the first signal component, which yields crosstalk.

FIG. 6C illustrates the power levels of the signals after adjustment by polarization controller 24. The polarization may be adjusted to compensate for the change during transmission. For example, polarization controller 80 may realign the state of polarization of the two incoming signal components to the axes of the polarization beam splitter 84. In this example, the output of polarization beam splitter 84 may provide the maximum rejection of the unwanted signal components along Eₓ and E_{y}. In the example, the first signal component has power level 112c, and the second signal component has power level 114c.

According to one embodiment, polarization controller monitor 98 may monitor the polarization indicating waveforms of the signal components to determine if the polarization state of the received signal has been properly aligned with polarization beam splitter 84 by polarization controller 80.

According to one embodiment, if the polarization state of the received signal has been properly polarized, the polarization indicating waveforms at receiver 28 should be substantially similar to the polarization indicating waveforms at transmitter 20. For example, in the illustrated embodiment, polarization indicating waveforms at receiver 28 should be 1−0.05*cos (2nf₀t) and 1+0.05*cos (2nf₀t) . If the polarization indicating waveforms are not substantially similar, then polarization controller monitor 98 may instruct polarization controller 80 to adjust the polarization.

Polarization controller monitor 98 may monitor the polarization indicating waveforms in any suitable manner. According to one embodiment, polarization controller monitor 98 may measure a polarization indicator value that represents the polarization indicating waveforms. If the measured polarization indicator value matches an expected polarization indicator value, then polarization may be determined to be proper. For example, in the illustrated embodiment, the expected polarization indicator value may be calculated from the difference of the expected polarization indicating waveforms 1−0.05*cos (2nf₀t) and 1+0.05*cos (2nf₀t), where the waveforms have been multiplied with a local oscillator signal and the product of these signals has been filtered out by a low pass filter (LPF). In the example, the expected polarization indicator value may be K.

Polarization controller monitor 98 may include any suitable components for monitoring the polarization indicating waveforms. According to the illustrated embodiment, polarization controller monitor 98 includes low speed detectors 110, a subtractor 116, a local oscillator 118, a mixer 120, and a low pass filter (LPF) 122 coupled as shown.

Detectors 110 detect the polarization indicating waveforms and generate a detector signal representing the polarization indicating waveforms. According to one embodiment, detectors 110 may comprise low speed detectors 110 that detect only the slowly varying components that represent the polarization indicating waveforms. In one embodiment, detector 110 may measure the encoded signal, which may be an optical signal, and may comprise a photodiode.

Subtractor 116, local oscillator 118, mixer 120, and low pass filter 122 may be used to measure the polarization indicator value. Subtractor 116 subtracts the signals from detectors 110. In the illustrated embodiment, the subtraction yields a current proportional to 0.1*cos (2nf₀t) . Mixer 120 multiplies the signal from subtractor 114 according to a local oscillator signal from local oscillator 118 to yield a current proportional to K+K*cos (4nf₀t) . The local oscillator signal may have a frequency of f₀. The cos (4nf₀t) component may be filtered out by a low pass filter to yield the polarization indicator value K. In the example, if the measured polarization indicator value matches the expected polarization indicator value K, then polarization setting of the polarization controller 80 may be designated as proper. Otherwise, the polarization may be adjusted.

The polarization may be adjusted in any suitable direction. According to one embodiment, the polarization may be changed in one direction and the polarization indicator value may be measured. If the measured polarization indicator value is closer to the expected polarization indicator value, the change may continue in that direction. Otherwise, the change may be made in the other direction.

Modifications, additions, or omissions may be made to receiver 28 without departing from the scope of the invention. The components of receiver 28 may be integrated or separated according to particular needs. Moreover, the operations of receiver 28 may be performed by more, fewer, or other devices. Additionally, operations of receiver 28 may be performed using any suitable logic.

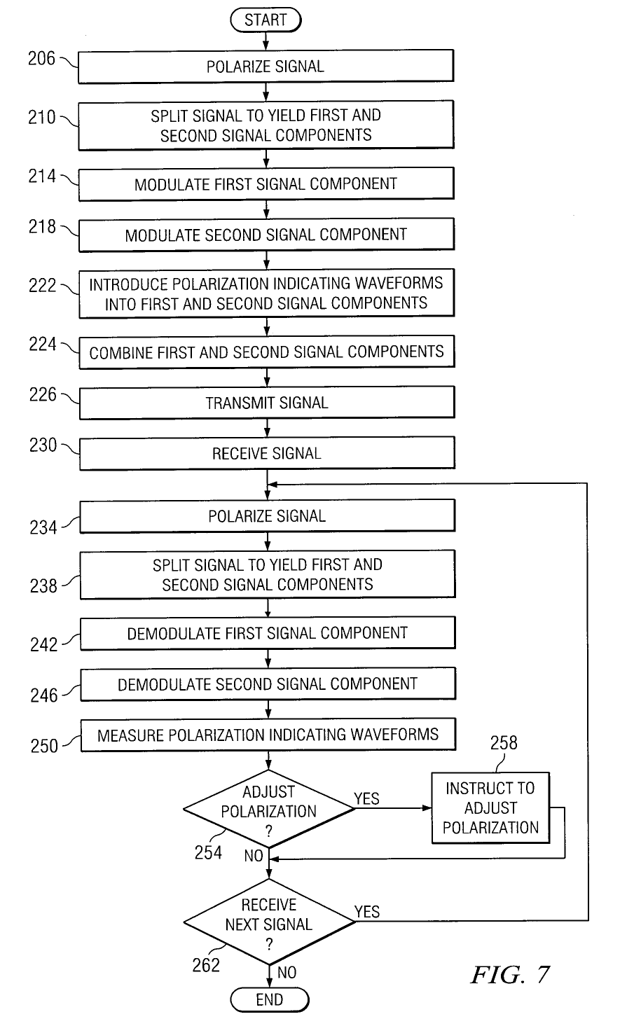

FIG. 7 illustrates one embodiment of a method for communicating a signal using polarization multiplexing. The method may be performed by system 10 of FIG. 1.

The method begins at step 206, where polarization controller 24 polarizes a signal. Polarization controller 24 may polarize a signal to yield orthogonal signal components. A polarization beam splitter 26 splits the signal at step 210 to yield the orthogonal signal components comprising a first signal component and a second signal component. The first signal component is modulated at step 214, and the second signal component is modulated at step 218. The first and second signal components may be modulated according to any suitable modulation format, for example, PSK modulation.

Polarization indicator modulator 40 modulates the first and second signal components at step 222 to introduce polarization indicating waveforms into the first and second signal components. Polarization beam combiner 50 combines the first and second signal components at step 224 to yield a signal for transmission. Transmitter 20 transmits the signal at step 226.

Receiver 28 receives the signal at step 230. Polarization controller 80 aligns the polarization state of the signal with the axes of polarization beam splitter 84 at step 234. Polarization beam splitter 84 splits the signal at step 238 to yield orthogonal signal components comprising the first signal component and the second signal component. The first signal component is demodulated at step 242, and the second signal component is demodulated at step 246.

Polarization controller monitor 98 measures the polarization indicating waveforms of the signal at step 250. In one embodiment, low speed detectors 110 may detect the waveforms. A measured polarization indicating value may be determined from the detected waveforms.

Polarization may need to be adjusted at step 254. If the measured polarization indicator value matches the expected polarization indicator value, then polarization may not need adjustment. Otherwise, polarization may need adjustment. If polarization needs adjustment at step 254, the method proceeds to step 258, where polarization controller monitor 98 instructs polarization controller 80 to adjust the polarization of the signal. The method then proceeds to step 262. If polarization does not need adjustment at step 254, the method proceeds to step 262.

Next signals may be received at step 262. If next signals are received, the method returns to step 234, where the next signals are polarized. If no next signals are received, the method terminates.

Modifications, additions, or omissions may be made to the method without departing from the scope of the invention. The method may include more, fewer, or other steps. Additionally, steps may be performed in any suitable order.

Certain embodiments of the invention may provide one or more technical advantages. A technical advantage of one embodiment may be that signal components communicated using polarization multiplexing may have polarization indicating waveforms that a receiver may use to monitor polarization. In the embodiment, a transmitter may modulate signal components to introduce polarization indicating waveforms into the signal components. A receiver may use the polarization indicating waveforms to determine whether the received signal components are being properly polarized.

A technical advantage of one embodiment may be that the receiver may measure a polarization indicating value representing the polarization indicating waveforms. In the embodiment, if the measured polarization indicator value does not match an expected polarization indicator value, the receiver may initiate polarization adjustment.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the following claims.

What is claimed is:

1. A transmitter modulator operable to communicate a signal using polarization multiplexing, comprising:
a first modulator operable to:
encode a first signal component according to a first modulation format;
a second modulator operable to:
encode a second signal component according to a second modulation format, the first signal component orthogonally polarized with respect to the second signal component;
a polarization indicating modulator coupled to the first modulator and the second modulator and operable to:
modulate the first signal component to introduce a first polarization indicating waveform into the first signal component; and
modulate the second signal component to introduce a second polarization indicating waveform into the second signal component; and
a polarization beam combiner coupled to the polarization indicating modulator and operable to:
combine the first signal component and the second signal component for transmission.

2. The transmitter modulator of claim 1, wherein:
the first modulation format is substantially similar to the second modulation format.

3. The transmitter modulator of claim 1, wherein:
the first modulation format refers to phase-shift keying (PSK) modulation.

4. The transmitter modulator of claim 1, wherein the first polarization indicating waveform has:
a frequency less than one ten-thousandth of a bit rate of the combined signal.

5. The transmitter modulator of claim 1, wherein the first polarization indicating waveform has:
an amplitude less than one-fourth of a total power.

6. The transmitter modulator of claim 1, further comprising a phase shifter operable to:
introduce a phase shift between the first polarization indicating waveform and the second polarization indicating waveform.

7. The transmitter modulator of claim 1, further comprising a transmitter polarization controller coupled to the first modulator and the second modulator and operable to:
polarize a signal to yield a polarized signal comprising the first signal component and the second signal component.

8. The transmitter modulator of claim 1, further comprising a polarization beam splitter coupled to the first modulator and the second modulator and operable to:
split a polarized signal to yield the first signal component and the second signal component.

9. A method for communicating a signal using polarization multiplexing, comprising:
encoding a first signal component according to a first modulation format;
encoding a second signal component according to a second modulation format, the first signal component orthogonally polarized with respect to the second signal component;
modulating the first signal component to introduce a first polarization indicating waveform into the first signal component;
modulating the second signal component to introduce a second polarization indicating waveform into the second signal component; and
combining the first signal component and the second signal component for transmission.

10. The method of claim 9, wherein:
the first modulation format is substantially similar to the second modulation format.

11. The method of claim 9, wherein:
the first modulation format refers to phase-shift keying (PSK) modulation.

12. The method of claim 9, wherein the first polarization indicating waveform has:
a frequency less than one ten-thousandth of a bit rate of the combined signal.

13. The method of claim 9, wherein the first polarization indicating waveform has:
an amplitude less than one-fourth of a total power.

14. The method of claim 9, further comprising:
introducing a phase shift between the first polarization indicating waveform and the second polarization indicating waveform.

15. The method of claim 9, further comprising:
polarizing a signal to yield a polarized signal comprising the first signal component and the second signal component.

16. The method of claim 9, further comprising:
splitting a polarized signal to yield the first signal component and the second signal component.

17. A system for communicating a signal using polarization multiplexing, comprising:
means for encoding a first signal component according to a first modulation format;
means for encoding a second signal component according to a second modulation format, the first signal component orthogonally polarized with respect to the second signal component;
means for modulating the first signal component to introduce a first polarization indicating waveform into the first signal component;
means for modulating the second signal component to introduce a second polarization indicating waveform into the second signal component; and
means for combining the first signal component and the second signal component for transmission.

18. A transmitter modulator operable to communicate a signal using polarization multiplexing, comprising:
a transmitter polarization controller operable to:
polarize a signal to yield a polarized signal comprising a first signal component and a second signal component;
a polarization beam splitter operable to:
split the polarized signal to yield the first signal component and the second signal component;
a first modulator operable to:
encode the first signal component according to a first modulation format, the first modulation format referring to phase-shift keying (PSK) modulation;
a second modulator operable to:
encode the second signal component according to a second modulation format, the first signal component orthogonally polarized with respect to the second signal component, the first modulation format substantially similar to the second modulation format;
a polarization indicating modulator coupled to the first modulator and the second modulator and operable to:
modulate the first signal component to introduce a first polarization indicating waveform into the first signal component, the first polarization indicating waveform having:
a frequency less than one ten-thousandth of a bit rate of the combined signal; and
an amplitude less than one-fourth of a total power; and
modulate the second signal component to introduce a second polarization indicating waveform into the second signal component;
a phase shifter operable to:
introduce a phase shift between the first polarization indicating waveform and the second polarization indicating waveform; and
a polarization beam combiner coupled to the polarization indicating modulator and operable to:
combine the first signal component and the second signal component for transmission.

19. A system operable to monitor polarization of a signal, comprising:
a polarization controller operable to:
polarize a signal to yield a polarized signal comprising a first signal component and a second signal component, the first signal component orthogonally polarized with respect to the second signal component; and
a polarization controller monitor coupled to the polarization controller and operable to:
monitor a first polarization indicating waveform of the first signal component;
monitor a second polarization indicating waveform of the second signal component; and
determine whether to adjust polarization of the signal in accordance with the first polarization indicating waveform and the second polarization indicating waveform.

20. The system of claim 19, wherein:
the first signal component is encoded according to a first modulation format; and
the second signal component is encoded according to a second modulation format, the first modulation format substantially similar to the second modulation format.

21. The system of claim 19, wherein:
the first signal component is encoded according to phase-shift keying (PSK) modulation.

22. The system of claim 19, wherein the first polarization indicating waveform has:
a frequency less than one ten-thousandth of a bit rate of the combined signal.

23. The system of claim 19, wherein the first polarization indicating waveform has:
an amplitude less than one-fourth of a total power.

24. The system of claim 19, wherein the polarization controller monitor is operable to determine whether to adjust polarization of the signal by:
measuring a polarization indicating value representing the first polarization indicating waveform and the second polarization indicating waveform; and
adjusting polarization of the signal if the measured polarization indicator value does not match an expected polarization indicator value.

25. The system of claim 19, wherein the polarization controller monitor is operable to determine whether to adjust polarization of the signal by:
measuring a polarization indicating value using a difference between the first polarization indicating waveform and the second polarization indicating waveform; and
determining whether to adjust polarization of the signal in accordance with the measured polarization indicating value.

26. The system of claim 19, wherein the polarization controller monitor further comprises:
a first detector operable to detect the first polarization indicating waveform; and
a second detector operable to detect the second polarization indicating waveform.

27. The system of claim 19, further comprising a polarization beam splitter operable to:
split the polarized signal to yield the first signal component and the second signal component.

28. A method for monitoring a polarization controller, comprising:
polarizing a signal to yield a polarized signal comprising a first signal component and a second signal component, the first signal component orthogonally polarized with respect to the second signal component;
monitoring a first polarization indicating waveform of the first signal component;
monitoring a second polarization indicating waveform of the second signal component; and
determining whether to adjust polarization of the signal in accordance with the first polarization indicating waveform and the second polarization indicating waveform.

29. The method of claim 28, wherein:
the first signal component is encoded according to a first modulation format; and
the second signal component is encoded according to a second modulation format, the first modulation format substantially similar to the second modulation format.

30. The method of claim 28, wherein:
the first signal component is encoded according to phase-shift keying (PSK) modulation.

31. The method of claim 28, wherein the first polarization indicating waveform has:
a frequency less than one ten-thousandth of a bit rate of the combined signal.

32. The method of claim 28, wherein the first polarization indicating waveform has:
an amplitude less than one-fourth of a total power.

33. The method of claim 28, wherein determining whether to adjust polarization of the signal further comprises:
measuring a polarization indicating value representing the first polarization indicating waveform and the second polarization indicating waveform; and
adjusting polarization of the signal if the measured polarization indicator value does not match an expected polarization indicator value.

34. The method of claim 28, wherein determining whether to adjust polarization of the signal further comprises:
measuring a polarization indicating value using a difference between the first polarization indicating waveform and the second polarization indicating waveform; and
determining whether to adjust polarization of the signal in accordance with the measured polarization indicating value.

35. The method of claim 28, further comprising:
detecting the first polarization indicating waveform; and
detecting the second polarization indicating waveform.

36. The method of claim 28, further comprising:
splitting the polarized signal to yield the first signal component and the second signal component.

37. A system for monitoring polarization of a signal, comprising:
means for polarizing a signal to yield a polarized signal comprising a first signal component and a second signal component, the first signal component orthogonally polarized with respect to the second signal component;
means for monitoring a first polarization indicating waveform of the first signal component;
means for monitoring a second polarization indicating waveform of the second signal component; and
means for determining whether to adjust polarization of the signal in accordance with the first polarization indicating waveform and the second polarization indicating waveform.

38. A system operable to monitor polarization of a received signal, comprising:
a polarization controller operable to:
polarize a signal to yield a polarized signal comprising a first signal component and a second signal component, the first signal component orthogonally polarized with respect to the second signal component, wherein:
the first signal component is encoded according to a first modulation format;
the second signal component is encoded according to a second modulation format, the first modulation format substantially similar to the second modulation format; and
the first signal component is encoded according to phase-shift keying (PSK) modulation;
a polarization beam splitter operable to:
split the polarized signal to yield the first signal component and the second signal component; and
a polarization controller monitor coupled to the polarization controller and operable to:
monitor a first polarization indicating waveform of the first signal component, the first polarization indicating waveform having:
a frequency less than one ten-thousandth of a bit rate of the combined signal; and
an amplitude less than one-fourth of a total power;
monitor a second polarization indicating waveform of the second signal component; and
determine whether to adjust polarization of the signal in accordance with the first polarization indicating waveform and the second polarization indicating waveform by:
measuring a polarization indicating value representing the first polarization indicating waveform and the second polarization indicating waveform;
measuring the polarization indicating value using a difference between the first polarization indicating waveform and the second polarization indicating waveform; and
determining whether to adjust polarization of the signal in accordance with the measured polarization indicating value; and
adjusting polarization of the signal if the measured polarization indicator value does not match an expected polarization indicator value, the polarization controller monitor further comprising:
a first detector operable to detect the first polarization indicating waveform; and
a second detector operable to detect the second polarization indicating waveform.
